(19) United States
(12) Patent Application Publication
(10) Pub. No.: US 2003/0188095 A1
(43) Pub. Date: Oct. 2, 2003

(54) Method for dynamically determining optimal write speed of optical disk

(76) Inventors: Gang-Ming Fan, Taipei (TW); Yung-Yu Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/404,549

(22) Filed: Apr. 2, 2003

Related U.S. Application Data
(63) Continuation-in-part of application No. 09/834,607, filed on Apr. 16, 2001, now abandoned.

(51) Int. Cl. G06F 12/00

(52) U.S. Cl. 711/112

(57) ABSTRACT

A method for dynamically determining optimal write speed of optical disk is proposed. The target beta value and the power limit of laser are determined firstly. The optimum power control process is taken and the optimal power is compared with the power limit. If the optimal power is larger than the power limit, the write speed is reduced and optimum power control process is taken until the optimal write speed is found.

### FIELD OF THE INVENTION

The present invention relates to a method for dynamically determining optimal write speed of optical disk, especially to a method for dynamically determining optimal write speed of optical disk, wherein the write speed is reduced if the optimal power is larger than the power limit, thus ensuring the write quality.

### BACKGROUND OF THE INVENTION

As the need for large data storage capacity becomes urgent, a write-once type disk such as a compact-disk recordable (CD-R) or a rewritable type disk such as a compact-disk rewritable (CD-RW) are developed to provide large data storage. Taking CD-RW as example, it uses a phase-change material as record medium. The phase-change material has optical contrary between crystalline and amorphous regions and can be subjected to thermal treatment for quenching to an amorphous state from a crystalline state or annealing to a crystalline state from an amorphous state. The thermal treatment is performed by a laser diode, which can provide collimated light with high optical power to heat the phase-change material.

The write power level of laser diode will influence the quality of reproduced signal from a recorded disk. FIG. 1 shows an AC coupled radio frequency (RF) signal reproduced from a CD-RW disk. The AC coupled RF signal is the AC component signal by filtering out a DC component from the reproduced read signal. A characteristic beta value (β) is defined as beta=(P+B)/(P−B), wherein P is the peak value of envelope in FIG. 1 and B is the bottom value of envelope in FIG. 1, respectively. FIG. 2 shows a beta versus write-power curve for a specific disk. As shown in FIG. 2, the beta value is increased as write power from laser diode is increased. When the write power is increased, the DC component in read signal is reduced such that the absolute value of peak value P is larger than the absolute value of bottom value B, resulting a larger beta value. As also shown in FIG. 2, a parameter jitter characterizing time domain error has minimum for a specific beta value (βₒ). The specific beta value is referred to target beta value and the write power (Pₒ) obtaining the target beta value is referred to optimum write power. To ensure data integrity, an optimum power control (OPC) procedure is performed before recording data to a CD-R disk or a CD-RW disk to determine the optimum write power and to achieve target beta value and minimal jitter. Generally, the beta versus write-power curves may have different slopes for different manufacturers. More particularly, the target beta value for a specific disk is increased as the writing speed is increased. In other word, the optimum write power of the laser diode should be increased correspondingly. However, a laser diode generally has a maximum output power, i.e., a laser power limit, to ensure normal operation and expectant lifetime. Therefore, the optimum power control (OPC) procedure should be prudently designed to ensure the laser diode being operated within the laser power limit.

A conventional optimum power control (OPC) method is carried out with a beta measurement. As shown in FIG. 3, this conventional method comprises following steps:

Step 11: Starting optimum power control (OPC) procedure for an optical disk drive. A plurality of test data is written to predetermined frames in a power calibration area (PCA) of a CD-R disk with different write powers. The write power starts from an initial power and then increases at a predetermined power step.

Step 12: Conducting a beta measurement method for the test data. The test data are reproduced by the optical disk drive to generate corresponding test signals. The test signals are filtered out DC component to obtain AC coupled RF signals. A characteristic beta value beta (β) with above-mentioned definition is measured for each test data corresponding to a specific write power. Therefore, the relationship between beta and write power for a specific write speed and specific disk can be derived and used for optimization.

Step 13: Determining whether optimal write power is found. The measured beta values are examined to find whether one measured beta value is matched to the target beta value with minimal jitter. If one measured beta value is matched to the target beta value, the write power corresponding to the measured beta value is optimal write power and the procedure is proceeded to and ended in a step 18. If no measured beta value is matched to the target beta value, then a measured beta value closest to the target beta value is selected for further optimization in next step 14.

Step 14: Judging whether the selected measured beta value is smaller than the target beta value. If true, a new write power is obtained in step 15 by increasing the write power corresponding to the selected measured beta value and then the procedure is proceeded to step 16, else a new write power is obtained in step 19 by decreasing the write power corresponding to the selected measured beta value and then the procedure is proceeded to step 12.

Step 16: Checking the feasibility of write power. The new write power is compared with the laser power limit of a writing laser diode. If the new write power is larger than the laser power limit, the procedure is proceeded to step 17 for reporting error; else the procedure is proceeded to step 12.

Therefore, by setting the target beta value for the optical disks, the optimum write power for the optical disks can be defined. As the write speed of the compact disk recorder becomes more and more rapid, the 12-× speed, 16-× speed and even the 20-× speed is realized. The write power of the compact disk recorder is also increased. However, the recording layer of different recordable optical disks may have characteristics of great variances. The write powers for different recordable optical disks are also different, even though at the same write speed. Moreover, the compact disk recorder has restricted write power limit, some recordable optical disks may have problem to find target beta value (i.e., optimum write power) at high write speed. The recordable optical disks cannot be written or have unsatisfactory result at that write speed.

### SUMMARY OF THE INVENTION

It is the object of the present invention to provide a method for dynamically determining optimal write speed of optical disk, thus protecting the writing laser diode of CD-R and ensuring write quality.

To achieve above object, the present invention provides a method for dynamically determining optimal write speed of optical disk, comprising following steps:

In an optimum power control procedure, finding a selected beta value closest to a target beta value; if the selected beta value is smaller than the target beta value, then proceeding a finding procedure for finding a new write power corresponding to the target beta value by adjusting a write power corresponding to the selected beta value; and in the finding procedure, if the adjusted write power is larger than a laser power limit, then reducing a write speed of the optical disk.

### BRIEF DESCRIPTION OF DRAWINGS

FIG. 1 shows an AC coupled radio frequency (RF) signal reproduced from a CD-RW disk;

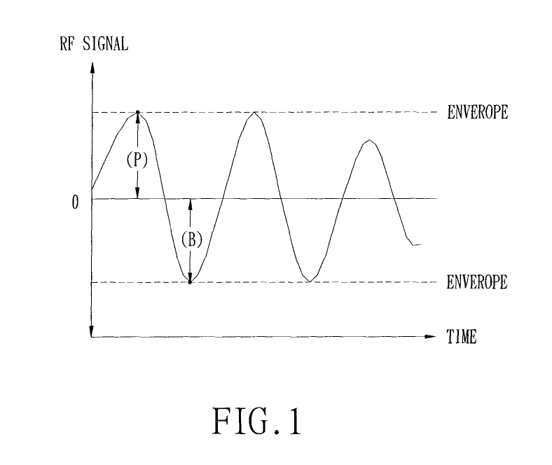

FIG. 2 shows a beta versus write-power curve for a specific disk;

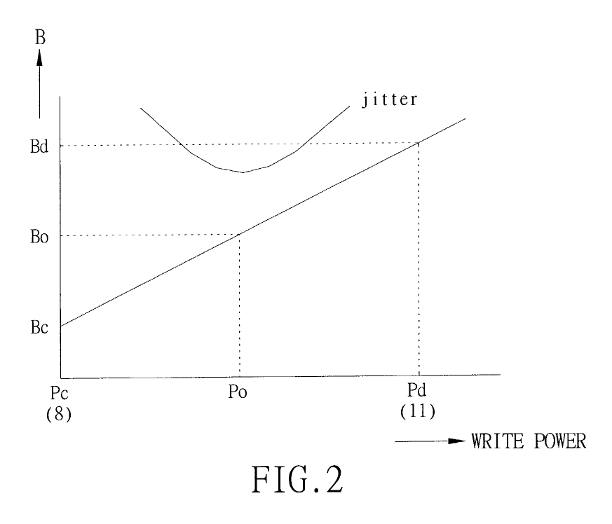

FIG. 3 shows the flowchart of conventional optimum power control (OPC) method;

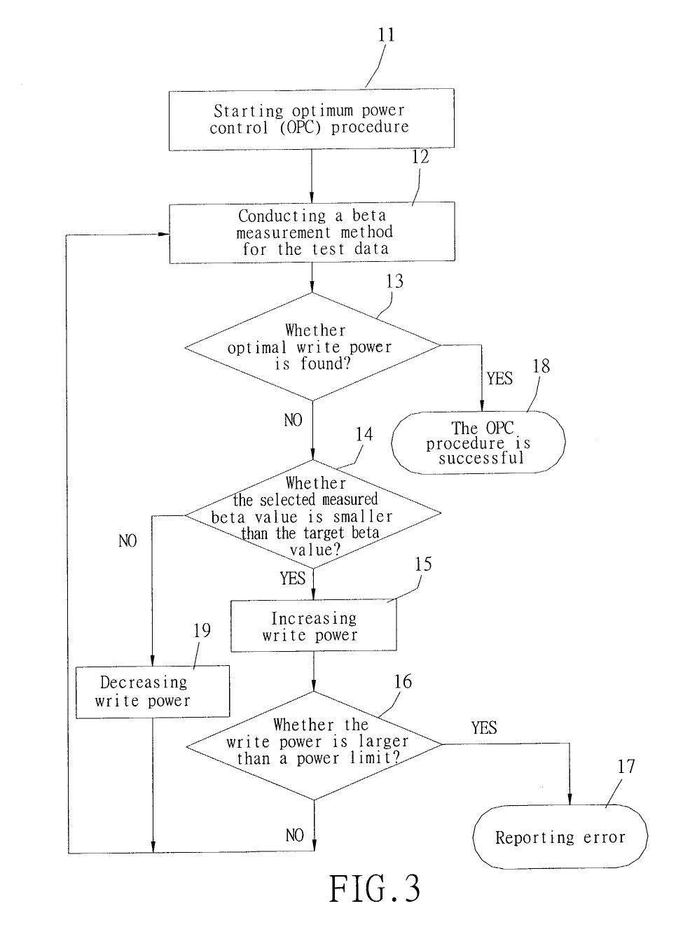

FIG. 4 shows the relationship of beta value with respect to the write power at various write speed; and

FIG. 5 shows the flowchart of method for dynamically determining optimal write speed of optical disk according to the present invention.

### DETAILED DESCRIPTION OF THE INVENTION

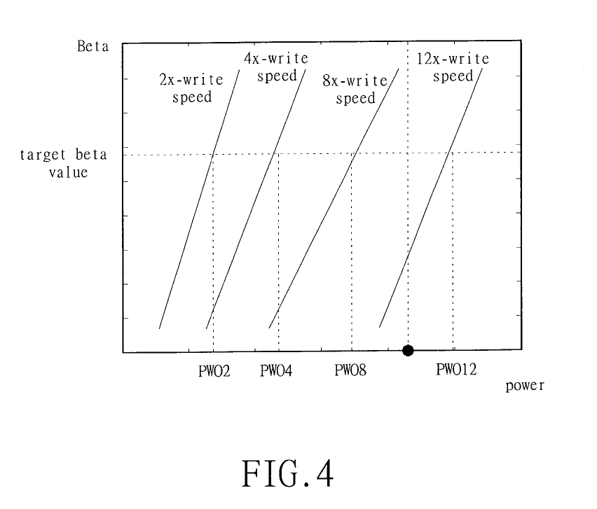

FIG. 4 shows the relationship of beta value with respect to the write power at various write speed (12-×, 8-×, 4-× and 2-×). As shown in this figure, the optimum write power PWO12 of 12-× write speed exceeds the power limit. The optimum write power PWO8 of 8-× write speed, PWO4 of 4-× write speed and PWO2 of 2-× write speed are within the power limit. Therefore, the compact disk recorder operates at high write speed requires higher write power. However, the life of the compact disk recorder is inversely proportional to the write power and write time. Therefore, it is precautions to prevent the compact disk recorder from operating at write power more than the power limit for any recording medium. To guarantee the write power being less than the power limit, the write power and, accordingly, the write speed is influenced and not optimal one.

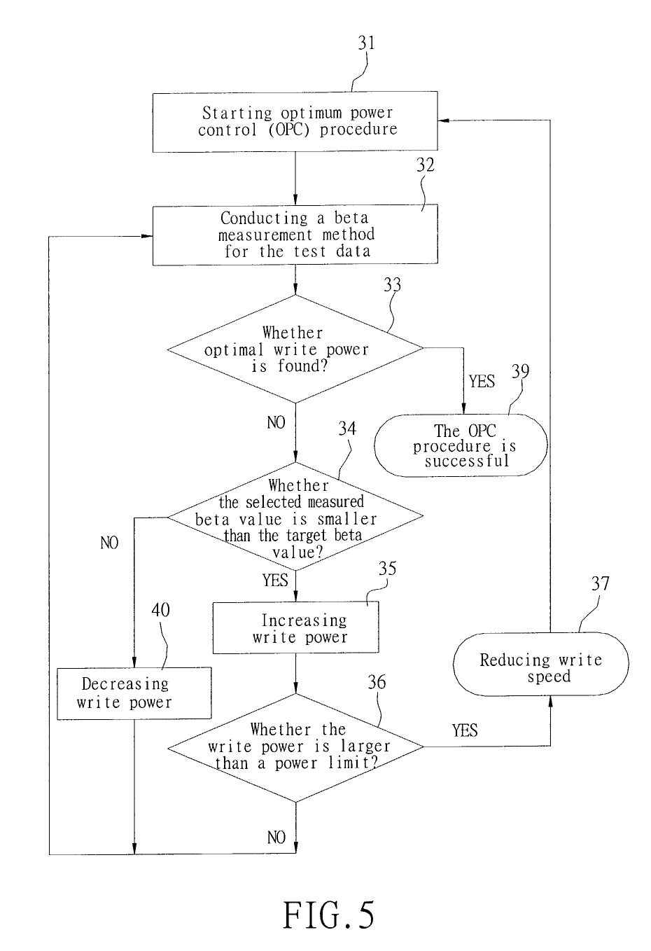

FIG. 5 shows the flowchart of method for dynamically determining optimal write speed of optical disk according to the present invention. The steps of the inventive method comprises following steps:

Step 31: Starting optimum power control (OPC) procedure for an optical disk drive. A plurality of test data is written to predetermined frames in a power calibration area (PCA) of a CD-R disk with different write powers. The write power starts from an initial power and then increases at a predetermined power step.

Step 32: Conducting a beta measurement method for the test data. The test data are reproduced by the optical disk drive to generate corresponding test signals. The test signals are filtered out DC component to obtain AC coupled RF signals. A characteristic beta value beta (β) with above-mentioned definition is measured for each test data corresponding to a specific write power. Therefore, the relationship between beta and write power for a specific write speed and specific disk can be derived and used for optimization.

Step 33: Determining whether optimal write power is found. The measured beta values are examined to find whether one measured beta value is matched to the target beta value with minimal jitter. If one measured beta value is matched to the target beta value, the write power corresponding to the measured beta value is optimal write power and the procedure is proceeded to and ended in a step 39. If no measured beta value is matched to the target beta value, then a measured beta value closest to the target beta value is selected for further optimization in next step 34.

Step 34: Judging whether the selected measured beta value is smaller than the target beta value. If true, a new write power is obtained in step 35 by increasing the write power corresponding to the selected measured beta value and used to write a new test data and then the procedure is proceeded to step 36; else a new write power is obtained in step 40 by decreasing the write power corresponding to the selected measured beta value and used to write a new test data and then the procedure is proceeded to step 32.

Step 36: Checking the feasibility of write power. The new write power is compared with the laser power limit of a writing laser diode. If the new write power is larger than the laser power limit, the procedure is proceeded to step 37, else the procedure is proceeded to step 32.

Step 37: The write speed of the optical disk drive is reduced and the procedure is proceeded to step 31.

To sum up, the method for dynamically determining optimal write speed of optical disk according to the present invention can find an optimal write speed while the write power is within the power limit. The writing quality is ensured.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A method for dynamically determining optimal write speed of optical disk recorded by an optical disk recorder, comprising following steps:
(a) writing a plurality of test data to predetermined location in the optical disk for an initial write speed;
(b) measuring a plurality beta values for the test data;
(c) determining whether any one of the beta values is matched to a target beta value for the optical disk, if true, a write power corresponding to the beta value matched to the target beta value is set to be optimal write power, else finding a selected beta value closest to the target beta value and proceeding to step (d)
(d) examining whether the selected beta value is smaller than the target beta value, if false, a new write power is obtained by decreasing a write power corresponding to the selected beta value and used to write a new test data, and then proceeding to step (b);
(e) obtaining a new write power is obtained by increasing a write power corresponding to the selected beta value;
(f) examining whether the new write power is larger than a laser power limit of a writing laser diode used for recording, if false, then the new write power is used to write a new test data and proceeding to step (b); and
(g) reducing write speed for the optical disk and then proceeding to step (a).

2. The method for dynamically determining optimal write speed of optical disk as in claim 1, wherein the target beta value in step (c) is optimized with respect to disk type and write speed.

3. The method for dynamically determining optimal write speed of optical disk as in claim 1, wherein the laser power limit of the writing laser diode in step (f) depends on specification of the writing laser diode.

4. The method for dynamically determining optimal write speed of optical disk as in claim 1, wherein the write speed in step (g) is reduced with reference to the allowable write speed of the optical disk recorder and the write speed selected by user.

5. The method for dynamically determining optimal write speed of optical disk as in claim 4, wherein the write speed selected by user has a minimum equal to the lowest write speed of the optical disk recorder.

6. A method for dynamically determining optimal write speed of optical disk recorded by an optical disk recorder, comprising following steps:
(a) determining a write speed of an optical disk;
(b) starting a optimum power control procedure for obtaining a plurality of beta values;
(c) finding a selected beta value in said beta values closest to a target beta value;
(d) if said selected beta value is smaller than said target beta value, then proceeding a finding procedure for finding a new write power corresponding to said target beta value by adjusting a write power corresponding to said selected beta value; and
(e) in said finding procedure, if said adjusted write power is larger than a laser power limit, then reducing said write speed of said optical disk.

7. The method for dynamically determining optimal write speed of optical disk as in claim 6, wherein said target beta value is optimized with respect to disk type and write speed.

8. The method for dynamically determining optimal write speed of optical disk as in claim 6, wherein said laser power limit depends on a specification of a writing laser diode.

9. The method for dynamically determining optimal write speed of optical disk as in claim 6, wherein said write speed in step (e) is reduced with reference to a plurality of allowable write speeds of the optical disk recorder.
